(19) United States
(12) Patent Application Publication
(10) Pub. No.: US 2008/0077295 A1
(43) Pub. Date: Mar. 27, 2008

(54) Stabilizing system and method for directionally stabilizing a vehicle by reference to a lateral force coefficient

(75) Inventors: Frederic Holzmann, Neutaubling (DE); Peter Koleszar, Budapest (HU); Ansgar Maisch, Ettlingen (DE); Sascha Paasche, Tokyo (JP); Andreas Schwarzhaupt, Landau (DE); Gernot Spiegelberg, Heimsheim (DE); Armin Sulzmann, Heidelberg (DE); Balazs Trecseni, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme Fuer Nutzfahrzeuge GmbH, Muenchen (DE)

(21) Appl. No.: 11/889,807

(22) Filed: Aug. 16, 2007

Related U.S. Application Data
(63) Continuation of application No. PCT/EP2006/001180, filed on Feb. 10, 2006.

(30) Foreign Application Priority Data
Feb. 16, 2005 (DE) 10 2005 007 213.5
Aug. 4, 2005 (DE) 10 2005 036 708.9

(51) Int. Cl. G05D 1/00; G06F 17/10

(52) U.S. Cl. 701/43

(57) ABSTRACT

A system and a method for directionally stabilizing a vehicle with the aid of a steering system used for influencing a steering angle of the vehicle steered wheels and a stabilizing system which controls the steering system for increasing the vehicle directional stability is provided. The stabilizing system is characterized in that the stabilizing system controls the steering system according to the lateral force factor of at least one steered wheel for defining the steering angle stabilizing the vehicle, wherein the stabilizing system adjusts the slip angle of the steered wheels in such a way that the lateral force factor does not substantially exceed the maximum range thereof.

### CROSS-REFERENCE TO RELATED APPLICATIONS

This application is a continuation of PCT International Application No. PCT/EP2006/001180, filed on Feb. 10, 2006, which claims priority under 35 U.S.C. § 119 to German Application No. 10 2005 007 213.5, filed Feb. 16, 2005 and German Application No. 10 2005 036 708.9, filed Aug. 4, 2005, the entire disclosures of which are expressly incorporated by reference herein.

### BACKGROUND AND SUMMARY OF THE INVENTION

The invention relates to a stabilizing system and a method for directionally stabilizing a vehicle, having a steering system for influencing a steering angle of steered wheels of the vehicle, and having a stabilizing unit which control the steering system in order to directionally stabilize the vehicle.

Such a stabilizing system is described, for example, in German Patent document DE 103 03 154 A1. Unstable vehicle behavior or anticipated unstable driving behavior is corrected in the known stabilizing system by changing the steering angle in such a way that as the driver steers the vehicle in the direction of an understeering course of the vehicle.

European Patent document EP 0 487 967 A2 discloses a vehicle with an antilock brake control system in which, in the case of rear wheel steering, a compensation steering angle is superimposed in order to compensate for a yaw moment caused by braking. Such a yaw moment arises, for example, when the vehicle is braked on a roadway with different grip values (μ split).

However, it is also possible for other driving situations to occur in which an active steering intervention is expedient, but is difficult to implement. For example, one such situation is if a vehicle oversteers or understeers when cornering. However, it is always problematic that known systems are reactive and they only perform measures for stabilizing the vehicle when the vehicle is already unstable.

An object of the present invention is, therefore, to develop a stabilizing system and a method of the type mentioned above such that improved directional stabilization is made possible on the basis of a steering intervention. In particular, a predictive steering intervention is to be made possible, which compensates unstable driving states of the vehicle in an ideal case even before they occur, at least however as early as possible.

This object is achieved by a stabilizing system of the type mentioned above in which the stabilizing unit actuates the steering system as a function of a lateral force coefficient of at least one of the steered wheels in order to set a steering angle, which stabilizes the vehicle, with the stabilizing unit setting a slip angle of the steered wheels in such a way that the lateral force coefficient essentially does not exceed the region of its maximum value. In addition, a method according to the invention and a vehicle with a stabilizing system according to the invention are provided.

A basic idea of the invention is to evaluate, by reference to a lateral force coefficient, the maximum achievable side force of a steered wheel (preferably of both steered wheels) in a vehicle with front axial steering, or of all the steered wheels in a vehicle with dual axle steering, and to take this into account in the determination of an optimum steering angle to be set. The stabilizing system sets the steering angle in such a way that the steered wheels can, as far as possible, transmit maximum lateral forces. If the vehicle is, for example, traveling on an underlying surface with a low grip value, the stabilizing system according to the invention sets a lower steering angle than in the case of an underlying surface with a relatively high grip value or a relatively high lateral force coefficient. The stabilizing system determines a lateral force coefficient μₗₐₜ, for example by reference to a μₗₐₜ slip angle diagram and/or a μₗₐₜ lateral slip diagram, and in a subsequent step determines from the lateral force coefficient μₗₐₜ the maximum lateral force which can be set and which the steered wheel is capable of transmitting to the roadway. The maximum lateral force which can be set then forms, as it were, the upper limit for the steering angle to be set.

The stabilizing system according to the invention can be implemented here by way of hardware and/or software.

The stabilizing system according to the invention expediently also takes into account the longitudinal friction coefficient of the at least one steered wheel (and advantageously of all the steered wheels) in the determination of the slip angle. In this way, at the same time optimum control of the longitudinal dynamics of the vehicle is ensured. It is particularly expedient if the stabilizing system determines the optimum steering angle for the respective wheel by reference to a vectorial addition of a longitudinal force and lateral force of the respective steered wheel in the manner of the Kamm's circle in order to determine a maximum range of the achievable longitudinal force and of the achievable lateral force. The wheel can in this case transmit longitudinal force and lateral force to the roadway in an optimum fashion, which is of considerable advantage both when accelerating and when braking. In this case, the vehicle can be particularly reliably placed in a stable driving state since it can transmit the braking force to the roadway in an optimum fashion and at the same time the vehicle is kept on a course desired by the driver by the steering angle correction according to the invention.

The stabilizing system according to the invention preferably evaluates an “extended” Kamm's circle during the determination of the optimum steering angle to be set. This preferably three-dimensional Kamm's circle, which can also be referred to as a pie chart, contains further diagrams for the longitudinal friction coefficient and the lateral force coefficient of a respective steered wheel, in particular as a function of the respective slip and slip angle of the wheel.

For example, a number of driving situations in which the stabilizing system according to the invention appears expedient are presented below.

For example, when the vehicle is oversteered the stabilizing system gives rise to a steering angle which initiates understeering of the vehicle. The inverse case is expedient in which the stabilizing system counteracts understeering by way of a steering angle in the direction of oversteering. When the steering angle is respectively set, the stabilizing system expediently takes into account the respective lateral force coefficient and the longitudinal friction coefficient of the steered wheel. It is particularly expedient if the stabilizing system firstly brings about braking of one of the wheels in order to initiate oversteering, in order to subsequently intervene in the vehicle in a stabilizing fashion by way of a suitable steering intervention in the direction of understeering.

A combination of the stabilizing system according to the invention with an antilock brake control system (ABS) is particularly effective. For example, the stabilizing system can contain an antilock brake control system or interact with an antilock brake control system. The stabilizing system receives braking values which are set at the wheels of the vehicle by the antilock brake controller, these being for example values relating to the braking pressure and/or relating to a braking power of a wheel or the like. The braking values are advantageously setpoint values and/or actual values of the braking values which are to be set or are set at the brakes of the respective wheels.

The stabilizing system analyzes the braking values and/or a relationship between braking values which are set at wheels of one axle of the vehicle as a function of the respective coefficient of friction of the wheel. For example, a multichannel antilock brake system individually corrects the braking values of the wheels of the vehicle. The antilock brake system usually determines in each case a braking value individually for each wheel of the steered front axle and advantageously for each wheel of the rear axle. Such an antilock brake system is also referred to as an MIC (modified individual control) antilock brake system.

It is also possible to control both wheels of the rear axle by way of a single braking value control channel of the antilock brake system. If the vehicle is traveling on an underlying surface with different grip values and a so-called μ split situation is present, the antilock brake system controls the braking values of the wheels as a function of the respective coefficient of friction of the wheel in relation to the underlying surface, on which the wheel is moving, which has respectively different grip values. The wheel on the region of the roadway with the better grip or friction is, therefore, braked to a greater extent than the wheel on the region of the roadway with the poorer friction or grip, in particular the poorer longitudinal friction. This gives rise to a yawing movement of the vehicle.

The stabilizing system according to the invention counteracts this yawing movement by correspondingly correcting the steering angle. In the process, the stabilizing system expediently evaluates the respective brake value profiles of the two wheels which are traveling on different underlying surfaces. The control model of the antilock brake system is expediently stored in the stabilizing system according to the invention, for example in the form of a stored program code. Alternatively, the latter can be called at the antilock brake system so that the stabilizing system detects, as it were, predictably in advance which braking effect is brought about by the antilock brake system in order to stabilize the vehicle by corresponding countersteering, even before the undesired yawing movement starts. A steering intervention on the part of the driver is not necessary. The driver can set a steering angle at the steering handle, for example the steering wheel, which corresponds to the desired direction of travel. The stabilizing system according to the invention automatically corrects the undesired rotational movement caused by the antilock brake control system, by way of a superimposed or compensating steering angle setting.

It is particularly advantageous if the stabilizing system outputs one or more limiting values to the antilock brake controller so that the latter can determine the maximum braking value to be set at a wheel. The antilock brake controller brakes the wheels of the vehicle by reference to the limiting value only insofar as the stabilizing system can reliably stabilize the vehicle by corresponding countersteering. The stabilizing system expediently determines the limiting value as a function of the lateral force coefficient and/or the slip angle of the respective wheel.

The stabilizing system according to the system is also advantageous in a driving situation in which understeering occurs. For example, in an aquaplaning situation the steered wheels of the vehicle skid so that the vehicle can no longer be steered. In such a situation, an inexperienced driver frequently sets an unsuitable steering angle, for example an excessively large steering angle so that when the wheels grip the roadway better again the vehicle carries on moving in an undesired direction caused by the steering angle which has been set. In such a driving situation, the stabilizing system according to the invention sets the steering angle in such a way that the steered wheels can transmit a maximum lateral force. In the case of complete aquaplaning, this may mean, for example, that the stabilizing system sets the wheels in a direction which corresponds to the movement of the vehicle, for example straight ahead, so that the vehicle carries on moving in this direction when the lateral force, which can be transferred, rises quickly, in particular suddenly, when, for example, the vehicle arrives at an area of the roadway on which aquaplaning does not occur. This prevents an uncontrollable reaction by the vehicle and the vehicle remains stable in terms of movement.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematically illustrated vehicle with a stabilizing system according to the invention for performing directional stabilization;

FIG. 2 shows the vehicle from FIG. 1 in a cornering operation, which leads to oversteering behavior;

FIG. 3 shows the vehicle from FIG. 1 in a driving situation in which aquaplaning occurs;

FIG. 4 shows a diagram with exemplary profiles of lateral force coefficients and longitudinal friction coefficients as a function of slip λ at constant slip angles α₁ and α₂;

FIG. 5 shows a Kamm's circle with additionally indicated profiles of lateral force coefficient and longitudinal friction coefficient;

FIG. 6 shows the vehicle from FIG. 1 in a μ split driving situation;

FIG. 7 shows a diagram with braking value profiles which an antilock brake system on the vehicle sets in the driving situation from FIG. 6; and

FIG. 8 shows a diagram with exemplary profiles of lateral force coefficients as a function of a slip angle α.

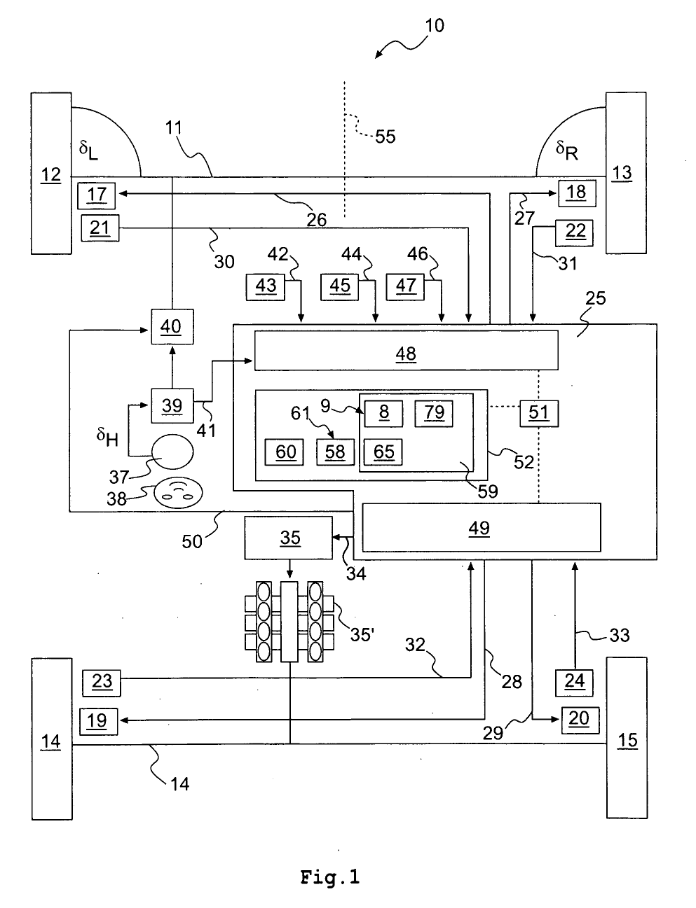

### DETAILED DESCRIPTION OF THE DRAWINGS

The vehicle 10 illustrated in the figures is, for example, a passenger car, a truck or a delivery vehicle.

The vehicle 10 includes a front axle 11 with steerable wheels 12, 13 and a rear axle 14 with non-steerable wheels 15, 16. Brakes 17, 18, 19, 20 for braking the respective wheels and rotation speed sensors 21 to 24 for sensing the respective wheel speeds of the wheels 12, 13, 15, 16 are arranged on the wheels 12, 13, 15, 16.

The brakes 17 to 20 can, as is illustrated schematically by arrows, be actuated by a stabilizing system 25 by way of brake intervention signals 26 to 29.

The rotational speed sensors 21 to 24 transmit rotational speed measured values 30 to 33 in the form of corresponding rotational speed signals, which represent the rotational speed of the respective wheel 12, 13, 15, 16, to the stabilizing system 25.

In addition, the stabilizing system 25 can actuate an engine controller 35 via an engine control signal 34, for example in order to throttle the engine power of an engine 35′ which, for example, drives the front axle 11 and/or the rear axle 14 of the vehicle 10.

A driver 38 can predefine steering instructions at a steering wheel 37 or some other steering handle. For example, a steering sensing device 39 senses the respective desired steering angle δₕ and passes it on to a steering actuator 40 for steering the wheels 12, 13. In addition, the steering sensing device 39 transmits a desired steering angle signal 41 with the desired steering angle δₕ to the stabilizing system 25.

The steering actuator 40 can be, for example, a component of an active steering system and/or superimposition steering system which superimposes a torque and/or an angle on the desired steering angle δₕ of the driver 38. However, a particularly preferred variant of the invention provides for the steering actuator 40 to be able to set a steering angle δ independently of the steering request by the driver 38, and for it to be, for example, a component of a so-called steer-by-wire steering system.

The stabilizing system 25 stabilizes the vehicle 10 by braking interventions and/or interventions which control the engine 35′ and/or steering interventions, for example if the vehicle 10 threatens to tip over, to skid, or to become unstable in terms of movement in some other way.

The stabilizing system 25 preferably evaluates sensor signals which are necessary for the directional stabilization of the vehicle 10 in any case and which are supplied, for example, by the rotation speed sensors 21 to 24 in the form of the rotational speed values of the wheels 12, 13, 14, 15.

In addition, the stabilizing system 25 expediently evaluates a yaw rate signal 42 with a yaw rate ψ of a yaw sensor 43, a yaw acceleration signal 44 with a yaw acceleration value a_{y} of a lateral acceleration sensor 45 which is installed transversely with respect to the longitudinal axis 55 of the vehicle, and/or a velocity signal 46 with the velocity v of the vehicle 10 which is determined by a velocity device 47. The velocity signal 46 is determined by the velocity device 47 by reference to the rotational speed values of the wheels 12, 13, 14, 15.

The stabilizing system 25 is implemented here as a module, which contains both hardware and software. For example, there are input devices 48 and output devices 49 which sense the above-mentioned signals of the sensors 21 to 24, 43, 45, 47, 54 and generate corresponding control signals, for example the engine control signal 34, the brake intervention signals 26 to 29 and a steering signal 50 for actuating the steering actuator 40. The input devices 48 and output devices 49 contain, for example, one or more bus controllers and/or digital and/or analog input devices and/or output devices. The stabilizing system 25 also contains a processor or a plurality of processors 51, which implement a program code which is respectively made available by program modules and which is stored in a memory 52 with, for example, a volatile and/or nonvolatile memory. The program modules contain, for example, an antilock brake control module 58 and an ESP (Electronic Stabilization Program) module 59, and advantageously a TC (traction controller) module 60. The modules 58, 59, 60 form a stabilizing system 61.

The ESP module 59 which is configured according to the invention and the ABS module 58 operate as follows.

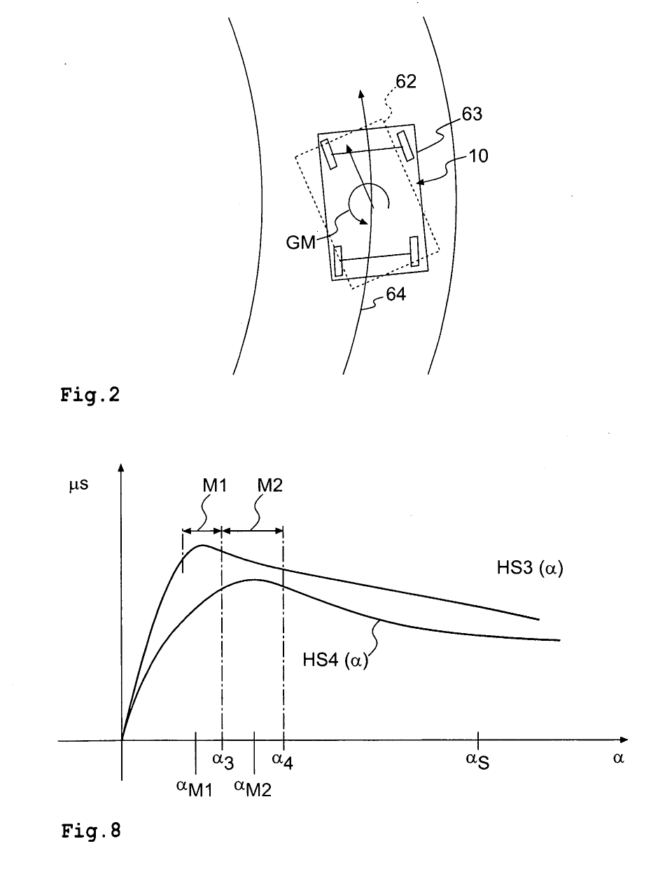

When cornering according to FIG. 2, the vehicle 10 would, under certain circumstances, oversteer with conventional technology and it would assume an oversteering vehicle position 62 in which the rear of the vehicle 10 veers off, i.e. swings out to the outside of the bend. However, the ESP module 59 uses the steering angle signal 50, which generates a steering function 8, to influence the steering actuator 40 predictively or at least reactively at an early point so that the vehicle essentially does not oversteer and travels through the curve path 64 set by the driver 38 at the steering wheel 37 in the driving position 63 shown by continuous lines. The steering actuator 40 and the steering function 8 form the steering device 9.

The ESP module 59 generates the steering signal 50 to actuate the steering actuator 40 by way of the steering angle signal 41, the velocity signal 46, the yaw rate signal 42 and the lateral acceleration signal 44. The values contained in these signals are input into a control model 65 of the ESP module 59, which represents both the longitudinal dynamics and the transverse dynamics of the vehicle 10.

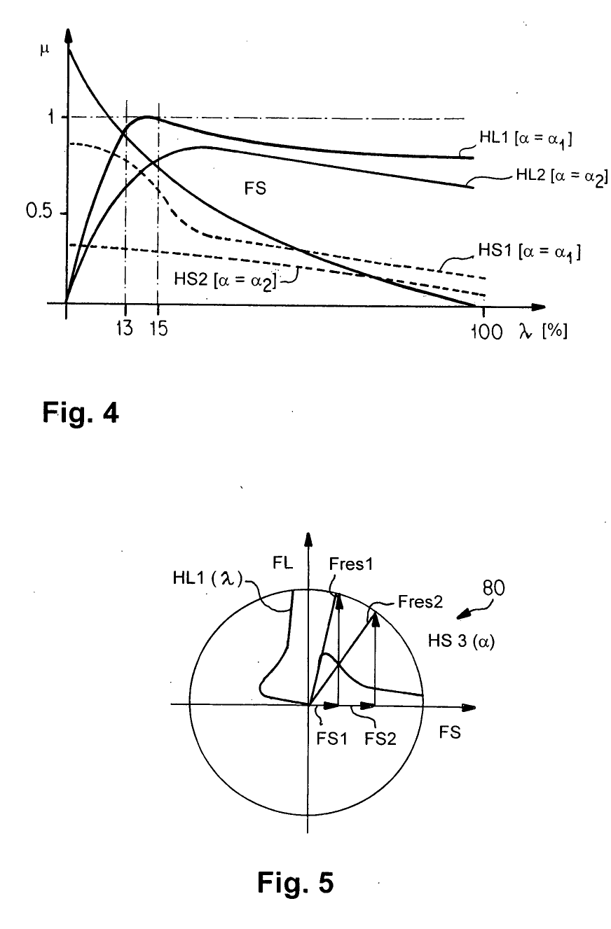

In order to determine the steering angle δ or steering angle δ_{L} and δ_{R} which are to be set individually at the wheels 12, 13, the ESP module 59 additionally evaluates, according to the invention, a lateral force coefficient μₛ of the steered wheels 12, 13. In addition, the ESP module 59 takes into account a longitudinal friction coefficient μ_{L} in order to determine an optimum steering angle δ of the steered wheels 12, 13. For example, the ESP module 59 analyzes for this purpose lateral force coefficient profiles HS1, HS2, which are dependent on a slip λ, at constant slip angles α₁ and α₂ according to FIG. 4 and/or lateral force coefficient profiles HS3, HS4 according to FIG. 8 which are dependent on a slip angle α, as well as further lateral force coefficient profiles which are not illustrated in FIG. 4 or FIG. 8. In addition, the ESP module 59 expediently analyzes longitudinal friction coefficient profiles HL1, HL2.

The slip angle α is the angle between the center plane of a respective wheel 12, 13 and the instantaneous direction of movement of the wheel 12, 13. The slip angle α is, for example 2°, the slip angle α₂ is, for example 10°. By way of example, the profile of a lateral guiding force FS is also indicated in the diagram in FIG. 4. The slip angle α corresponds to a difference in lateral slip between the steering angle δ, which is set, and the actual direction of travel of the wheel 12, 13.

The ESP module 59 then firstly determines, by reference to a yaw moment GM to be compensated, a necessary lateral force FS which the steered wheels 12, 13 have to provide in order to hold the vehicle 10 on the curved path 64 or to move it into the curved path 64. By reference to the side force FS, the ESP module 59 then determines a slip angle α which is to be set at the wheels 12. 13. The ESP module 59 takes into account a profile of the lateral force coefficient μₛ here as a function of the slip angle α which is to be set.

Exemplary lateral force coefficient profiles HS3(α) and HS4(α) are illustrated in FIG. 8. The profile HS3 corresponds to a relatively high lateral force coefficient μₛ or to relatively high friction of the wheels 12, 13 on the roadway, and the profile HS4 corresponds to relatively low friction and to a relatively low lateral force coefficient μₛ. The lateral force coefficient HS3 rises up to a maximum value of α_{M1} and then decreases significantly as the slip angle α increases. The lateral force coefficient HS3 has a maximum region M1 which decreases significantly from a slip angle α₃. The lateral force coefficient HS4 has an overall lower profile than the lateral force coefficient HS3, for example because the roadway has a lower grip value. The lateral force coefficient HS4 rises up to a maximum value α_{M2} and decreases significantly from a slip angle α₄. The lateral force coefficient HS4 has its maximum area m2 between the slip angles α₃ and α₄.

The ESP module 59 then evaluates the μ_{S} slip angle diagram illustrated by way of example and schematically in FIG. 8 in order to determine the maximum settable lateral force and sets the steering angle δ in such a way that the maximum slip angles α₁ or α₂ for the lateral force coefficients HS3 and HS4 are not exceeded. Further deflection of the wheels 12, 13 would in fact not show any effect since the friction between the wheels 12, 13 and the roadway is not sufficient to make available the corresponding lateral force FS.

However, the ESP module 59 goes one step further: in addition it evaluates the profile of the assigned longitudinal friction coefficient μ_{L} of the wheels 12, 13, for example their reference to the profiles HL1, HL2 according to FIG. 4. The ESP module 59 also expediently uses a so-called Kamm's circle 80 to determine the maximum lateral force FS to be set and the associated longitudinal force FL. The Kamm's circle or tire-road adhesion circle 80 is additionally extended by lateral force coefficient profiles HS as a function of the slip angle α and by longitudinal friction coefficient profiles HL as a function of the slip λ, for example by the profiles HS3 and HL1. The ESP module 59 additionally evaluates these profiles, as described above. The profiles HS1 to HS4, HL1 and HL2 as well as further profiles which are not illustrated in FIG. 4 are stored, for example, in the memory 52.

The ESP module 59 adds the longitudinal force FL to be set and the lateral force FS vectorially so that, for example, the resulting forces Fres1 and Fres2 are produced. For compensating the yaw moment GM, a lateral force FS2 which is assigned to a slip angle α₅ would be expedient. However, the ESP module 59 uses the diagram 80 to determine that the lateral force coefficient μ_{S} has already significantly exceeded its maximum value at this slip angle. The ESP module 59 determines, for example using the lateral force coefficient profile HS3(α), the slip angle α₃ or the maximum value α_{M1} as an optimum slip angle, which values are lower than the slip angle α₅ so that the lateral force coefficient μₛ does not exceed, or at least does not significantly exceed, the region of its maximum value M1. The ESP module 59 then determines a steering angle δ as a function of the lateral force FS1 and/or of the optimum slip angle α_{M1} or α₃, and transmits the steering angle δ to the steering actuator 40 within the scope of the steering angle 50.

The steering actuator 40 then sets the wheels 12, 13 to the steering angle δ. The wheel 12 therefore adopts the steering angle δ_{L}, and the wheel 13 adopts the steering angle δ_{R}, with the two steering angles δ_{L} and δ_{R} having a fixed relationship with one another here, for example because the wheels 12, 13 are coupled to one another by way of a steering trapezium.

However, in this context, it is to be noted that an individual setting of the steering angles δ_{L} and δ_{R} by the steering actuator 40 can expediently be adjusted. In this case, the ESP module 59 determines both steering angles δ_{L}, δ_{R}, advantageously as a function of the respective individual lateral force coefficient μ_{S} of the wheels 12, 13 in the fashion explained above.

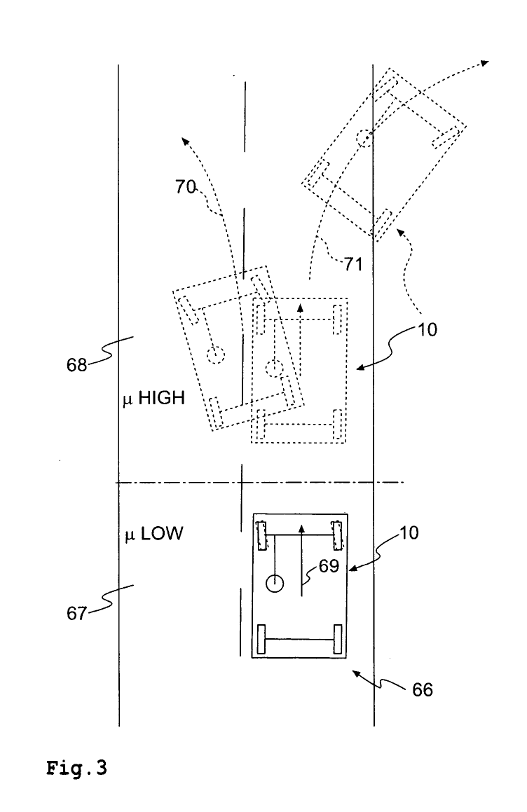

FIG. 3 shows a further driving situation of the vehicle 10, specifically a μ jump driving situation in which the ESP module 59 according to the invention proves advantageous.

The vehicle 10 is traveling, for example, from a roadway section 67 of the roadway 66 with a low coefficient of friction μ (μ low) into a roadway section 68 with a high coefficient of friction μ (μ high). For example, aquaplaning occurs on the roadway section 67, while in the roadway section 68 the wheels 12, 13 of the vehicle 10 have better adhesion to the roadway 66 because, for example, the water flows off better from the surface of the roadway 66. In a conventional vehicle, because the wheels 12, 13 are skidding, the driver 38 would then, for example, adjust the wheels 12, 13 into the oblique position shown by dashed lines. Nevertheless, the vehicle 10 would continue traveling in the direction of travel 69 since the wheels 12, 13 cannot transmit any lateral guiding forces to the roadway 66.

If the vehicle 10 then moves onto the roadway section 68 with relatively high friction, the vehicle 10 would then pass through the movement path 70, because the wheels 12, 13 have friction again, and in passing through this path the wheels 12, 13 would arrive on the oncoming roadway or leave the roadway 66 completely.

An experienced driver 38 would possibly counter this situation by way of a rapid countersteering reaction and would steer the vehicle 10 to the right. However, because the wheels 12, 13 have a surprisingly high grip value for the driver 38, that is to say can transmit high lateral forces, the driver 38 oversteers the vehicle 10 to a great extend so that the vehicle 10 then leaves the roadway 66 to the right on the movement path 71.

However, the ESP module 59 prevents the above-mentioned dangerous situations and keeps the vehicle 10 in the desired direction 69 of travel. The driver 38 expediently holds the steering wheel 37 in the straight ahead position. However, at other desired steering angles δ_{H} the ESP module 59 also steers the wheels 12, 13 in the straight ahead position in the roadway section 67, i.e., the μ low section. The ESP module 59 specifically determines, using the lateral force coefficients μ_{S} and the longitudinal friction coefficients μ_{L} in the manner described above, that a lateral guiding force for steering the wheels 12, 13 in the position shown by dashed lines on the basis of the low coefficient of friction μ low could not be transmitted to the roadway 66 and accordingly sets the wheels 12, 13 in the straight ahead position or approximately in the straight ahead position. If the vehicle 10 then moves onto the roadway section 68 with μ high, the steering angle δ of the wheels 12, 13 is at least approximately an optimum value so that the vehicle 10 continues to travel straight ahead, as illustrated according to FIG. 3. The vehicle 10 therefore behaves according to the expectations of the driver.

When cornering with a corresponding μ jump driving situation, the ESP module 59 would, for example, set the desired steering angle δ_{H}, insofar as the lateral force coefficient μ_{S} permits, at the wheels 12, 13, expediently taking into the account the yaw rate \dot{ψ}.

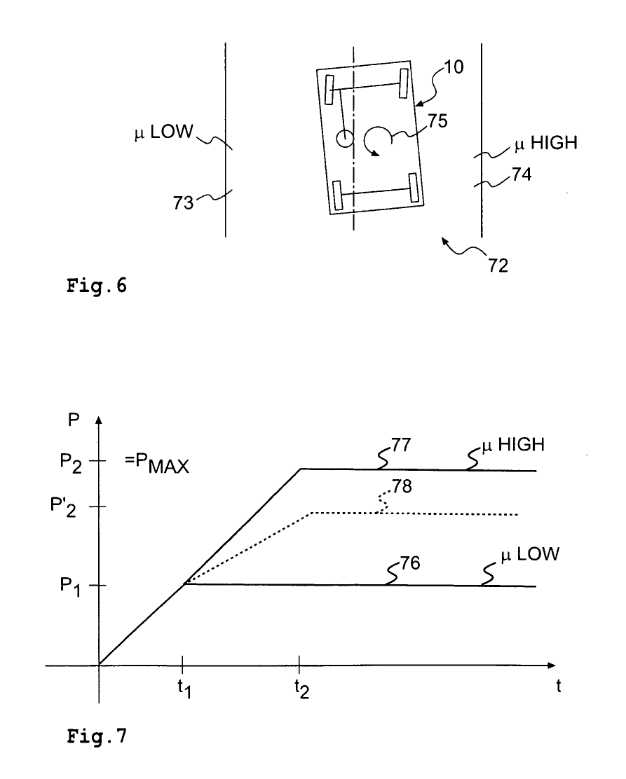

A roadway 72 which is illustrated in FIG. 6 has different grip values in the longitudinal direction. For example, the right-hand wheels 13, 15 of the vehicle 10 are on a roadway section 74 with μ high, and the left-hand wheels 12, 14 are on a roadway section 73 with μ low. This is therefore a so-called μ split driving situation. The antilock brake system 58 then brakes the wheels 12, 13, 14, 15 using the brakes 17 to 20 in as optimum a way as possible, i.e. the said system 58 sets lower braking values at the brakes 18, 20 than at the brakes 17, 19 in order to achieve as far as possible an optimum braking effect. However, this gives rise to a yaw moment 75, which per se would lead to an undesired yaw rotation of the vehicle 10. The ESP module 59 counteracts the yaw moment 75 predictively.

ABS module 58 increases, for example, the brake pressure at the brakes 17 to 20 initially up to a value P₁. The wheels 12 and 14 at the μ low roadway section 74 then already reach their maximum braking power. From this time t₁, the ABS module 58 keeps the brake value profile 76 for the brakes 17 and 19 essentially at the braking value P₁, control fluctuations about this value being present in practice. From the time t₁ to the time t₂, the ABS module 58 increases the brake pressure at the brakes 18 and 20 of the wheels 13 and 15 further up to a braking value P₂ so that the brake value profile 77 is set. The wheels 12 and 14 are thus also braked in an optimum way. The ABS module 58 expediently transmits to the ESP module 59 the brake value profiles 76 and 77 which are actually set at the brakes 17 to 20, and the ESP module 59 determines, in the way described above by reference to the relationship between the profiles 76, 77, a steering angle δ which is to be set at the wheels 12, 13. The ESP module 59 also takes into account the lateral force coefficient μ_{S} in this context so that a maximum lateral force FS and the same maximum yaw moment compensation are possible.

The control model 79 of the antilock brake module 58 is expediently stored in the ESP module 59 so that the antilock brake module 58 can, as it were, “predictively” determine the brake value profiles 76, 77 in order to be able to intervene in a compensating and driving-stabilizing fashion by way of corresponding steering angle corrections even before a negative yaw moment 75 arises.

If the maximum achievable lateral force value FS is exceeded and further countersteering or a further increase in the steering angle δ would become ineffective, the ESP module 59 expediently transmits to the ABS module 58 a maximum value PMAX, which in the present exemplary embodiment corresponds to the value P₂, so that the ABS module 58 does not increase the brake pressure at the brakes 17 and 19 beyond this value PMAX. The vehicle 10 is therefore braked to a maximum degree and nevertheless remains in the desired direction of travel set by the driver 38 at the steering wheel 37.

For the sake of comparison, a brake value profile 78 which represents the braking effect of a conventional antilock brake system is shown in FIG. 7. In this context, typical peripheral conditions are specified, specifically that the driver 38 can set a steering angle correction of a maximum of 120° at the steering wheel 37, which corresponds to a maximum braking value P′₂, and that the driver 38 can change the steering angle δ by 180° per second at maximum so that the increase in the brake value profile 78 is lower than that of the brake value profile 77. It is to be noted that the ABS module 58 can build up an optimum braking force more quickly by interacting with the ESP module 59 because the ESP module 59 compensates a resulting, undesired yaw moment 75 by correspondingly countersteering.

It goes without saying that the ESP module 59 can individually evaluate the physical conditions of all the wheels 12, 13, 14, 15, in particular the respective lateral force relationships, in the inventive way. The same applies to the ABS module 58, which can expediently brake each wheel 12, 13, 14, 15 individually with a maximum braking pressure, in which case the ESP module 59 carries out the necessary yaw moment compensation by steering the wheels 12, 13 (and also the wheels 15, 16 in the case of rear wheel steering).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for directionally stabilizing a vehicle, comprising:
a steering system for influencing a steering angle of steered wheels of the vehicle;
a stabilizing system which controls the steering system in order to directionally stabilize the vehicle;
wherein the stabilizing system actuates the steering system as a function of a lateral force coefficient of at least one of the steered wheels in order to set a steering angle that stabilizes the vehicle, the stabilizing system setting a slip angle of the steered wheels such that the lateral force coefficient essentially does not exceed a region of its maximum value.

2. The system as claimed in claim 1, wherein the stabilizing system is operatively configured to determine the slip angle as a function of a longitudinal friction coefficient of the at least one steered wheel.

3. The system as claimed in claim 1, wherein the stabilizing system is operatively configured to determine the slip angle as a function of at least one of a longitudinal slip and a transverse slip of the at least one steered wheel.

4. The system as claimed in claim 2, wherein the stabilizing system is operatively configured to determine the slip angle as a function of at least one of a longitudinal slip and a transverse slip of the at least one steered wheel.

5. The system as claimed in claim 1, wherein the stabilizing system is operatively configured to determine the slip angle by reference to a vectorial addition of a longitudinal force and a lateral force of at least one steered wheel in the manner of Kamm's circle in order to determine a maximum range of the achievable longitudinal force and lateral force.

6. The system as claimed in claim 5, wherein, during the vectorial addition of the longitudinal force and the lateral force, the stabilizing system evaluates a longitudinal friction coefficient which is assigned to the longitudinal force and the lateral force coefficient which is assigned to the lateral force.

7. The system as claimed in claim 1, wherein, when the vehicle is oversteered, the stabilizing system actuates the steering system to countersteer in a direction of understeering of the vehicle and/or when the vehicle is understeered the stabilizing system actuates the steering system to countersteer in a direction of oversteering the vehicle.

8. The system as claimed in claim 1, wherein the stabilizing system brings about oversteering of the vehicle by braking at least one wheel of the vehicle in order to then actuate the steering system in a direction of understeering of the vehicle.

9. The system as claimed in claim 1, wherein the stabilizing system interacts with, or has a part of, an antilock brake control system of the vehicle.

10. The system as claimed in claim 9, wherein the stabilizing system evaluates braking values, said braking values being determined and/or set by way of the antilock brake control system.

11. The system as claimed in claim 1, wherein the stabilizing system evaluates a relationship between at least two braking values which are set at wheels of an axle as a function of a coefficient of friction of the respective wheel.

12. The system as claimed in claim 1, wherein the stabilizing system determines the steering angle by reference to a braking value profile of a wheel with a relatively high coefficient of friction compared to a wheel with a relative low coefficient of friction.

13. The system as claimed in claim 9, wherein the stabilizing system outputs to the antilock brake control system a limiting value for a maximum braking value to be set at a wheel.

14. The system as claimed in claim 11, wherein the stabilizing system outputs to the antilock brake control system a limiting value for a maximum braking value to be set at a wheel.

15. The system as claimed in claim 13, wherein the stabilizing system determines the limiting value as a function of the lateral force coefficient and/or the slip angle of at least one of the steered wheels.

16. The system as claimed in claim 14, wherein the stabilizing system determines the limiting value as a function of the lateral force coefficient and/or the slip angle of at least one of the steered wheels.

17. The system as claimed in claim 1, wherein the stabilizing system is operatively configured to evaluate at least one of:
a steering angle, which is predefined at a steering handle of the vehicle;
a yaw value of the vehicle;
rotational speed values of the wheels of the vehicle;
a longitudinal speed value; and
an attitude angle of the vehicle.

18. A computer product for use in directionally stabilizing a vehicle, the computer product comprising a computer readable medium having stored thereon program code segments that:
influences a steering angle of steered wheels of the vehicle via a steering system;
controls the steering system in order to directionally stabilize the vehicle by activating the steering system as a function of a lateral force coefficient of at least one of the steered wheels in order to set a steering angle that stabilizes the vehicle; and
setting a slip angle of the steered wheels such that the lateral force coefficient essentially does not exceed a region of its maximum value.

19. A method for directionally stabilizing a vehicle in which a steering angle of steered wheels of the vehicle is influenced via an actuatable steering system, and a stabilizing system controls the steering system to directionally stabilize the vehicle, the method comprising the acts of:
determining at least one lateral force coefficient of the steered wheels of the vehicle;
actuating the steering system as a function of the determined at least one lateral force coefficient in order to set, using the stabilizing system, the steering angle which stabilizes the vehicle, wherein the stabilizing system sets a slip angle of the steered wheels such that the lateral force coefficient essentially does not exceed a region of its maximum value.

20. A motor vehicle, comprising:
a system for directionally stabilizing a vehicle, including:
a steering system for influencing a steering angle of steered wheels of the vehicle;
a stabilizing system which controls the steering system in order to directionally stabilize the vehicle;
wherein the stabilizing system actuates the steering system as a function of a lateral force coefficient of at least one of the steered wheels in order to set a steering angle that stabilizes the vehicle, the stabilizing system setting a slip angle of the steered wheels such that the lateral force coefficient essentially does not exceed a region of its maximum value.
